(19) United States
(12) Patent Application Publication
(10) Pub. No.: US 2005/0225675 A1
(43) Pub. Date: Oct. 13, 2005

(54) Device for receiving and displaying teletext pages, comprising a device for creating a personalised teletext page, and television receiver comprising said both devices

(75) Inventor: Xiaochun Lin, Singapore (SG)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., NL-5621 BA Eindhoven (NL)

(21) Appl. No.: 10/516,547

(22) PCT Filed: Jun. 4, 2003
(86) PCT No.: PCT/IB03/02534

§ 371 Date: Dec. 2, 2004

(30) Foreign Application Priority Data
Jun. 7, 2002 (SG) 02/00115

(51) Int. Cl. H04N 11/00

(52) U.S. Cl. 348/468

(57) ABSTRACT

The invention relates to device for receiving and displaying teletext pages allowing a user to create a personal teletext page. A user can create his personal teletext page by marking parts from teletext pages of interest to him and making these parts available at the personal teletext page. The personal teletext page can be edited and the various parts of the personal teletext page can be updated in real time.

The invention relates to a device for receiving and displaying teletext pages. Furthermore the invention relates to a television apparatus, a personal teletext page and to a computer program for creating such a personal teletext page.

During the last decades people have been exposed to an increasing amount of information. One example of a source providing large amounts of information is teletext. Almost every television nowadays is suited to receive and display this kind of information. Some teletext pages provide information that is frequently updated such as the latest news or stock information.

Given this increasing amount of information people are more or less obliged to be selective in choosing which information they want to be confronted with and which information not. In order to enable people to selectively read teletext pages, the pages have been itemised in main categories such as “latest news”, “sports”, “financial”, and “weather” which categories can contain various sub-categories. Numbers have usually been assigned to the categories and pages and subpages. Thus, the information is spread over several different pages and sub-pages as a consequence of which a user interested in some information items needs to call the individual pages of interest. Different users of teletext systems are likely to be interested in different categories of information.

European Patent EP 0 513 680 B1 reveals a transmission and reception system for teletext information, wherein single teletext pages for a particular chosen subject (stock, traffic) are collected at the broadcast side in a file containing the teletext pages. This file is transmitted to the receiver side using compression techniques. The file is decompressed at the receiver side and divided into the original files that constitute the single pages. This system allows users to choose teletext pages of interest and provides fast access to the pages.

A problem associated with the prior art teletext systems described above is that users of such teletext systems are still confronted with information that is of no interest to them. The stock-pages chosen by the user of the system in EP 513 680 e.g. still comprise lines with stock information of no relevance or interest to the user.

The invention aims to provide the user with a teletext system or device that confronts the user only with information that is of relevance for that user.

This aim is achieved by providing a user device for receiving and displaying teletext pages characterised in that said device comprises a module for:
marking at least one part in at least one first teletext page of said received teletext pages;
creating a second teletext page suited to accommodate a selected part, and
making available said marked part at said second teletext page by selecting said marked part.

By providing the user with such a device equipped with this module the user is enabled to select a part of a teletext page which part can be made available to another page so that this user can create a personal teletext page comprising only parts of teletext pages that have been selected by him, e.g. out of relevance considerations. This module thus enables the user to be confronted only with information that is of relevance or interest to him.

In an embodiment of the invention the module enables the second teletext page, hereinafter also referred to as the Personal Teletext Page or Personal Text Page, to be appended by further selected parts. These selected parts can originate from other parts of the first teletext page or sub-page or from other teletext pages or sub-pages if marked and selected by the user.

In an embodiment of the invention the module enables the marked part to comprise a single line in the first teletext page. This enables the user to mark and select e.g. the stock market price of only a single fund, if this fund has been assigned a single line on the first teletext page.

In an embodiment of the invention the selected part on the Personal Teletext Page is updated by the module in real time in response to an update of the part that was marked and selected by the user at the first teletext page. This real time update facility for the Personal Teletext Page is particularly advantageous for frequently changing information on teletext pages comprising parts that are of interest to the user, such as particular stock market prices, sports results and traffic information.

In an embodiment of the invention the module enables a user to edit the selected part on the Personal Teletext Page when it has been made available at this page. In particular the module enables the user to navigate through the first teletext page using a single line display window on the Personal Teletext Page. This facility enables the user to change previously selected parts

In an embodiment of the invention the selected part in the Personal Teletext Page serves as a link to the teletext page where the selected part was made available from. This expands the conventional text link function from a maximum of four links to a maximum of twenty-three links.

For users being interested in a large variety of information in an embodiment of the invention the module provides the user with the possibility to create multiple Personal Teletext Pages.

The invention also relates to a television apparatus comprising a module as discussed above.

Furthermore the invention relates to a computer program and a personalised teletext page. The computer program is suited for running on a processor and includes at least software code portions for marking at least one part in at least one first teletext page of the received teletext pages, creating a second teletext page suited to accommodate a selected part and making available said marked part at said second teletext page by selecting the marked part.

The personalised teletext page comprises at least one part made available from a first teletext page by selecting a marked part of said first teletext page and fetching said marked part to said personalised teletext page.

It is noted that the previous embodiments or aspects of the previous embodiments of the invention can be combined.

The embodiments of the invention will be described into more detail below with reference to the attached drawing of which

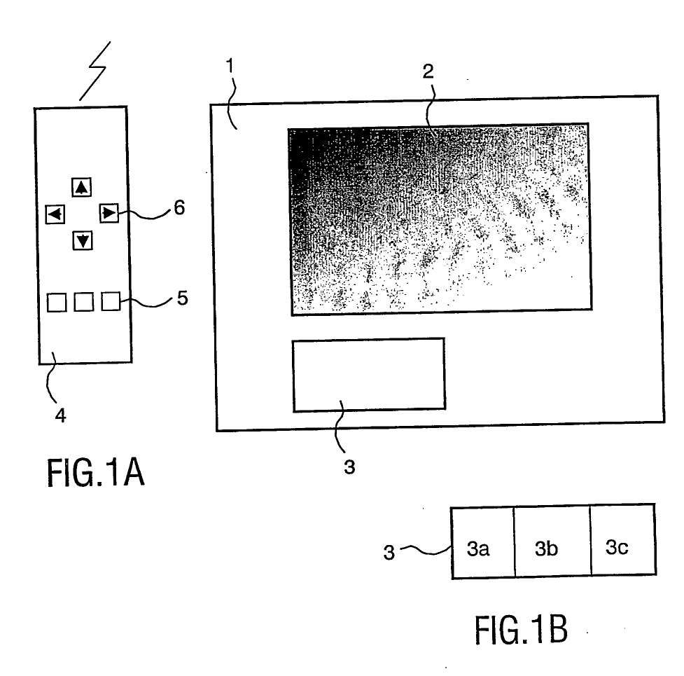

FIGS. 1A and B show a system comprising a user device for receiving and displaying teletext pages and a control apparatus for controlling said device.

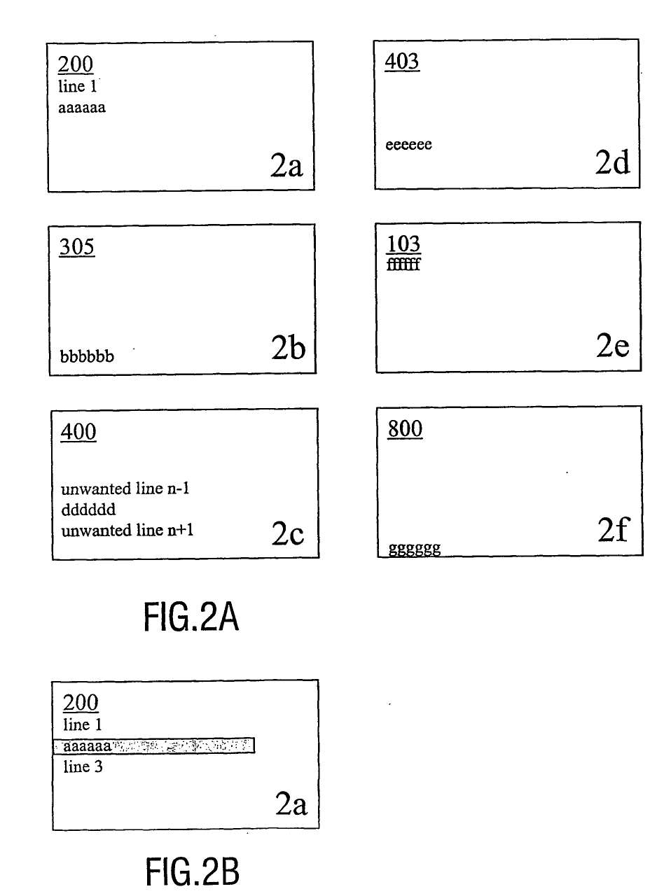

FIGS. 2A and B show six teletext pages comprising parts of interest to a particular user.

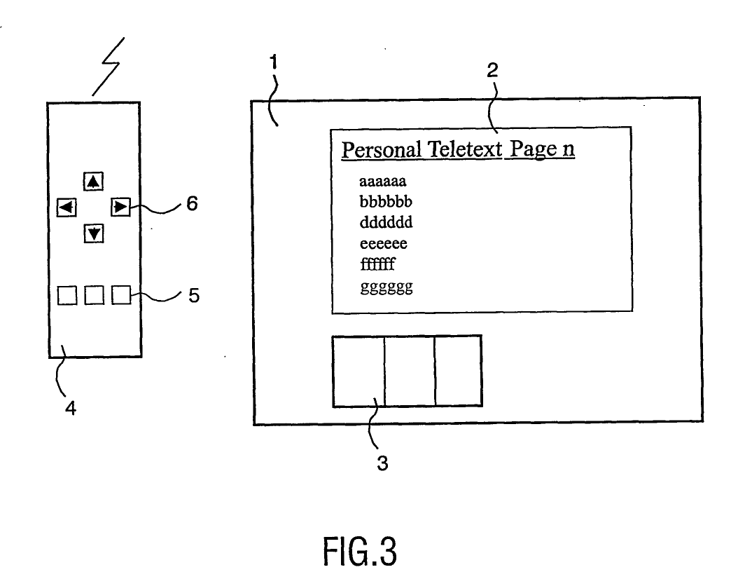

FIG. 3 shows an example of a personal teletext page.

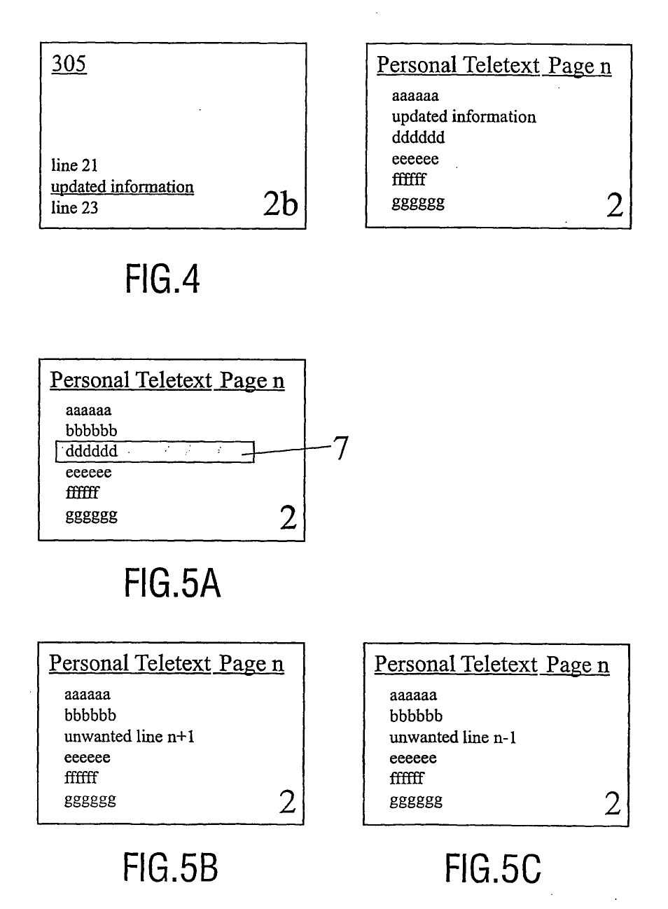

FIG. 4 illustrates the real-time update facility for the personal teletext page.

FIG. 5 illustrates the editing facility for the personal teletext page.

In FIG. 1A a system is shown comprising a user device 1 for receiving teletext pages and displaying these pages on a display 2 and a remote control 4. An example of such a user device 1 is a television apparatus comprising a teletext decoder or module 3. There are e.g. one-page, ten-page and hundred-page decoders. An example of a decoder chip is TDA956X, which is a television signal processor with a 8051 microcontroller.

A ten-page decoder can decode and store up to ten different teletext pages at the same time. A teletext page is stored at a memory block, specified by software, which memory block has a fixed starting address (hexadecimal, denoted as ‘h’). E.g. a ten-page decoder has ten memory blocks wherein block 0 starts at memory address 2000h till 23ffh, block I starts at 2800h till 2bffh, etc. Each memory block can be used to store a teletext page. Teletext page 200 can be stored at block I. For displaying a teletext page on the display 2 a memory block is specified as display memory. Note that different teletext decoders can have different memory addresses to store teletext information.

The remote control 4 communicates with the user device 1 and a user can control the operation of the user device 1 by pressing keys of key-sets 5 and 6. It will be appreciated that the remote control 4 usually comprises more keys (not shown).

For the purpose of the invention more specifically the remote control 4 communicates with the module 3. This module 3 comprises various sub-modules 3a, 3b and 3c as shown in FIG. 1B. These modules can be software modules. The teletext pages are received at the module 3. Sub-module 3a enables the user to mark a part of the received teletext page. Sub-module 3b is suited for creating a Personal Teletext Page. Sub-module 3c makes available the marked part to the Personal Teletext Page when this part is selected by the user.

For many users of teletext the information of relevance is spread over several different teletext pages. In FIG. 2A a situation is shown wherein only six teletext pages received at the user device 1 contain information of relevance to the user. The six pages shown on the display 2 of the user device 1 have the page numbers 200, 305, 400, 403, 103, and 800 (the pages shown on the display 2 are indicated by 2a, 2b, 2c, 2d, 2e and 2f for convenience; however the pages are normally displayed on a single display 2, e.g. a television screen).

A teletext page comprises 25 lines, each line having 40 characters. Each teletext line is stored in a memory block for the page at a fixed offset within that memory block. E.g. for page 200, stored at memory block I address 2800h, the first line starts at memory address 2820h.

Often a user is only interested in one or two parts, e.g. specific lines of information on the same teletext page. Referring to FIG. 2A the parts/lines of interest are indicated as parts aaaaaa, bbbbbb, dddddd, eeeeee, fffff and gggggg respectively. These parts of the teletext pages 200, 305, 400, 403, 103, and 800 can be marked by the user since the user device 1 comprises within module 3 a sub-module 3a providing a marking functionality. For convenience in the sequel it will be assumed that the parts refer to these lines. It will be appreciated that the markable parts can comprise any kind of information, i.e. the invention is not dependent on the kind of information presented on the teletext page or parts thereof.

The marking funcionality is facilitated by the sub-module 3a. The user can mark a line in a teletext page using the remote control 4 that co-operates with the module 3. If the user is interested in line aaaaaa on page 200, first block I is specified as display memory as a consequence of which page 200 is displayed on display 2. Module 3a might first hold block I to prevent rewriting of this block. The memory location of the first line is calculated. The sub-module 3a then overwrites the first character at 20h to 08h in the first line at 2820h in order to provide some kind of highlighting/flashing of the first line. It will be appreciated that there are many alternatives to highlight or mark a line such as displaying a “!” at the first column of a line in the teletext page.

If the user is interested in the second line aaaaaa, the user can mark this second line by pressing the DOWN key of key-set 6 on the remote control 4. Module 3a then restores the original value of th content of the first line at memory location 2820h, which means that the original display format is restored. The second line at memory location 2840h is then marked in the same way as described for the first line, as shown by the shaded area in FIG. 2B.

By receiving a particular signal from the remote control 4, the module 3b is activated to create a Personal Teletext Page suited to accommodate selected parts from the first teletext page(s). This signal originates from the remote control 4 when a user presses e.g. an EDIT PERSONAL TEXT key, being one of the keys of the key-set 5 on the remote control 4. The newly created Personal Teletext Page can be empty. This empty page can be shown to the user on the display 2 or the user is alerted that a new page has been created

By receiving a further signal from the remote control 4 the module 3, or more specifically the sub-module 3c, can be activated to make a selected part of a received teletext page available at the Personal Teletext Page. This further signal can be generated when the user marks and selects a preferred line on a teletext page. For example if the user decides to have the second line aaaaaa of page 200 for his Personal Teletext Page, he can select this line by pressing a key of the remote control 4. The page number and line number are stored and the content of this line is made available to the Personal Teletext Page by sub-module 3c.

The module 3 will first specify a memory block as display memory, e.g. block I, and then specify e.g. block 0 to store the text page 200. Note that in this example block I cannot be specified as a text page for page 200 since this block is here used for displaying the Personal Teletext Page on display 2 of user device 1. When the information is present in memory block 0, sub-module 3c makes the preferred line of the text page present in block 0 available at the Personal Teletext Page. In order to do so sub-module 3c can copy the content of the second line of page 200 (memory block starts at address 2840h) to block I. Line aaaaaa will be displayed on display 2.

This procedure can be repeated for other lines of interest to the user that might be on the same or a further teletext page. The sub-module 3c might use a first-in-first-served algorithm in appending the Personal Teletext Page with other parts selected by the user, such as bbbbbb from page 305. After the user has selected the lines in the six pages shown in FIG. 2A, the sub-module 3c makes available the following parts of the first teletext pages as selected parts at the Personal Teletext Page:
Line 1: page 200, line 2;
Line 2: page 305, line 22;
Line 3: page 400, line 16;
Line 4: page 403, line 13;
Line 5 page 103, line 1;
Line 6: page 800, line 23;

The user can leave the edit mode by e.g. pressing the EDIT PERSONAL TEXT key, being part of the key-set 5 on the remote control 4 again.

The user can activate the Personal Teletext Page, by e.g. pressing the PERSONAL TEXT key, being another key of the key-set 5 on the remote control 4. The module 3 will display the Personal Text Page on the display 2 of the user device 1 as shown in FIG. 3. The sub-module 3c enables the content of each selected line to be available at the Personal Text Page, by fetching the selected lines from the pages 200, 305, 400,403, 103, and 800 defined by the user when creating the Personal Teletext Page.

In FIG. 4 a feature of the embodiment is shown wherein a selected line of the Personal Teletext Page is updated in real-time. The situation is shown wherein the information contained in the line 22 of page 305 is updated (indicated as “updated information”) which update is immediately followed by an update of the selected part on the Personal Teletext Page. To be more specific, when an update of a selected line on page 305 is detected by the module 3, the sub-module 3c makes the updated line available at the Personal Teletext Page. This updating feature of the embodiment is realised for one, some or every selected part(s) in the Personal Teletext Page. When a user calls the Personal Teletext Page the latest relevant information is shown to him on the display 2 of the user device 1. The user of a device 1 might change his interest in the kind of information he wishes to be displayed on the Personal Teletext Page. The module 3 provides an editing functionality for editing the Personal Teletext Page or the selected parts thereof. This functionality is illustrated in FIG. 5. While displaying the Personal Teletext Page on display 2 the user can press the EDIT PERSONAL TEXT key of the key-set 5 on his remote control 4. He may select, e.g. by highlighting (shown by the shaded area in FIG. 5A) using the UP/DOWN key (key-set 6) on his remote control 4, a selected part on the Personal Teletext Page. In FIG. 5A this part is the line dddddd of page 400. The LEFT/RIGHT key, belonging to the key-set 6 as well, enables the user to navigate through that particular text page 400 which is made available at the Personal Text Page by sub-module 3c providing a link to that particular text page.

It is preferable that each line in the Personal Text Page can be used as a single line display window, indicated by 7 in FIG. 5A, for that particular text page. Therefore the module 3 is provided with means to present a line window 7 on the display 2 through which a user can navigate through a particular text page using the remote control 4. This means that the particular text page, here page 400 shown in FIG. 2A, display 2c can be partly “seen” through that window 7 in the Personal Text Page. The user can use the window 7 to navigate the particular text page line by line. This is shown in FIGS. 5B and 5C by the lines “unwanted line n+1” and “unwanted line n−1” which lines precede respectively follow the line dddddd of page 400. If e.g. the RIGHT key of the key set 6 on the remote control 4 is pressed the contents of the Personal Teletext Page shown in FIG. 5B is obtained which content is made available by sub-module 3c to the Personal Teletext Page. If the LEFT key of key set 6 is pressed, the Personal Teletext Page shown in FIG. 5C is obtained. If the user leaves the edit function, e.g. by pressing the EDIT PERSONAL TEXT key of the key-set 5 again, the new lines will be saved by the sub-module 3c. The new page and line information recorded on the Personal Teletext Page will replace the previous line number, so that the selected lines at the Personal Teletext Page are:
Line 1: page 205, line 22;
Line 2: page 305, line 1;
Line 3: page 400, line 15;
Line 4: page 403, line 13;
Line 5: page 103, line 1;
Line 6: page 800, line 23;

The module 3 enables the Personal Teletext Page to be used as a text link if an adequate signal from the remote control 4 is received. The user may first select a selected part of the Personal Teletext Page pressing the UP/DOWN key of the key-set 6. The adequate signal can subsequently be generated by the user pressing the TEXT MODE key, which is another key of the key-set 5 to instruct the module 3 to display the page from which the part was selected on the display 2 of the user device 1. For example if the third line of the Personal Teletext Page is linked to page 400 the user may select the third line in the Personal Teletext Page and press the TEXT MODE key on the remote control 4 to display page 400 on the display 2 of user device 1 (as shown in FIG. 2 on display 2c). Alternatively after selection of the third line on the Personal Teletext Page the user may press the LEFT/RIGHT key of key-set 6 to navigate page 400 line by line in the Personal Teletext Page. The new line numbers will not be recorded by the sub-module 3c for use in the the Personal Teletext Page. If the last number of a particular page is reached and the RIGHT key is pressed one more time the page number will increase by one (in this example to page 401) and the new line number will be reset to 1.

The sub-module 3b is suited to create multiple Personal Teletext Pages. This feature enables a particular user to have immediate access to lots of information that are of relevance to him even if the information of relevance can no longer be placed on a single Personal Teletext Page. Moreover this feature enables members of a community, such as a family, having different kind of interests for information to create a Personal Teletext Page for each member of that community using the same user device 1.

From the above it will be clear that the embodiments of the invention makes it more convenient for the user to read teletext information. The user may read all the information of interest or relevance to him on a single page. Moreover the user can personalise his information, i.e. organise the Personal Teletext Page according to his preferences. The user may e.g. create his personal stock page. The Personal Teletext Page no longer forces the user searching for information which is of interest to him to navigate through various different teletext pages as a consequence of which time can be saved. A particular advantage is that the user no longer needs to remember, wait or search for the pages or sub-pages containing the relevant information once he has created his Personal Teletext Page. The functions of teletext decode devices are fully utilised, since instead of only one page of information visible to a user, all information stored by the module is made visible to the user at the Personal Teletext Page. The text link function is expanded from a maximum of four links to a maximum of twenty-three links.

For the purpose of teaching the invention, a preferred embodiment of the device and the personalised teletext page has been described above. It will be apparent for the person skilled in the art that other alternative and equivalent embodiments of the invention can be conceived and reduced to practice without departing from the true spirit of the invention, the scope of the invention being only limited by the claims.

1. Device (1) for receiving and displaying teletext pages characterised in that said device comprises a module (3) for:
marking (3a) at least one part in at least one first teletext page of said received teletext pages;
creating (3b) a second teletext page suited to accommodate a selected part, and
making available (3c) said marked part at said second teletext page by selecting said marked part.

2. Device according to claim 0 wherein said module is suited for appending further selected parts to said selected part on said second teletext page.

3. Device according to claim 0 or 0 wherein said marked part is a single line in said first teletext page.

4. Device according to any of the preceding claims wherein said module is suited to update said selected part on said second teletext page in real time in response to an update of said part at said first teletext page.

5. Device according to any of the preceding claims wherein said module is suited to edit said selected part after said selected part has been made available on said second teletext page.

6. Device according to claim 0 wherein said selected part is a single line display window (7) at said second teletext page and said module is suited for navigating in said window through at least said first teletext page.

7. Device according to any of the preceding claims wherein said module is suited to make said selected part serve as a link to said first teletext page.

8. Device according to any of the preceding claims wherein said module is suited to create and/or append multiple second teletext pages.

9. Computer program for running on a processor at least including software code portions for creating a second teletext page suitable to accommodate a selected part by:
marking at least one part in at least a first teletext page;
making available said marked part at said second teletext page by selecting said marked part.

10. Personalized teletext page comprising at least one part made available from a first teletext page by selecting a marked part of said first teletext page and fetching said marked part to said personalised teletext page.

11. Television apparatus suited for receiving and displaying teletext pages comprising a module according to any of the claims 1-8 or a computer program according to claim 10.
